(19) United States
(12) Patent Application Publication
(10) Pub. No.: US 2014/0216146 A1
(43) Pub. Date: Aug. 7, 2014

(54) AIR PHYSICAL QUANTITY SENSING DEVICE

(71) Applicants: Takayuki Yogo, Hitachinaka-shi (JP); Takayuki Saito, Hitachinaka-shi (JP); Keiji Hanzawa, Hitachinaka-shi (JP)

(72) Inventors: Takayuki Yogo, Hitachinaka-shi (JP); Takayuki Saito, Hitachinaka-shi (JP); Keiji Hanzawa, Hitachinaka-shi (JP)

(73) Assignee: Hitachi Automotive Systems, Ltd.

(21) Appl. No.: 14/240,946

(22) PCT Filed: Jul. 31, 2012
(86) PCT No.: PCT/JP2012/069429

§ 371 Date: Feb. 25, 2014

(30) Foreign Application Priority Data
Sep. 20, 2011 (JP) 2011-204051

(51) Int. Cl. F02M 35/10

(52) U.S. Cl. CPC F02M 35/10373
USPC 73/114.31

(57) ABSTRACT

To prevent dew condensation on a sensor element, an air physical quantity sensing device which has a housing structural component integrally provided with a connector and a connector terminal member that perform input and output with the outside, an electronic circuit board mounted on the housing structural component, and an air physical quantity sensing element provided on the electronic circuit board and capable of detecting physical quantity of air. The housing structural component formed with a communication hole which allows the inside and outside of the main air flow passage to communicate with each other. The electronic circuit board has the communication hole separated into two and the surface on the side where the air physical quantity sensing element is provided faces the main air flow passage side.

### TECHNICAL FIELD

The present invention relates to a physical quantity sensing device that measures physical quantity, and particularly to an air physical quantity sensing device suitable for measuring physical quantity related to intake air of an internal combustion engine.

### BACKGROUND ART

An air physical quantity detection technology of an internal combustion engine is configured to be insulated from the repercussions of changes in environment, such as temperature. This is achieved by a placement of a measuring chamber communicating with at least one of a main air passage and a sub air passage in the middle of the passage farther from a passage wall of the main air passage than from the sub air passage, as in Patent Document 1.

### PRIOR ART LITERATURE

### Patent Documents

Patent Document 1: JP-2010-151795-A

### SUMMARY OF THE INVENTION

### Problems to be Solved by the Invention

In the technology described in the Patent Document 1, however, the measuring chamber in which a sensor is arranged is configured to be disposed in the middle of the passage in order to hinder the heat of a tube wall due to a temperature rise of the internal combustion engine from being conducted to an environment sensor element of the sensor. According to this configuration, the distance to a connector for performing input and output of signals from the environment sensor element will be long, thus correspondingly resulting in a complex structure constituted from a combination of plural parts and multi-step required in bonding, welding, or bonding process.

Further, when the temperature of the intake air suddenly has changed due to the sensor element exposed to the main air passage through a structure support, the surface temperature of each of the structure support and the sensor connected thereto changes with a delay.

Then, for example, when the engine is being operated at normal temperature; that is, when the intake air temperature has suddenly changed in an increasing direction from an area where the intake air temperature, the structure support, and the sensor element temperature are at the room temperature, the relation of their temperatures is expressed by “intake air temperature>structure support and sensor element temperature.” The air flowing nearly around the structure immediately reaches the dew point due to the repercussions of the structure at the room temperature, so that dew condensation occurs in the structure surface including the senor element. If this environment sensor is particularly a humidity sensor, its detection is deteriorated by the dew condensation.

An object of the present invention is to prevent dew condensation of a sensing element for detecting physical quantity of air.

### Means for Solving the Problems

In order to achieve the above object, there is provided an air physical quantity sensing device of the present invention, which includes a housing structural component integrally having a connector and a connector terminal member for performing input and output with the outside, an electronic circuit board mounted on the housing structural component, and an air physical quantity sensing element provided on the electronic circuit board, which is capable of detecting physical quantity of air and is attached and fixed using a part of the housing structural component to a mounting hole provided in advance at a part of a main air flow passage through which air flows. The electronic circuit board is mounted with electronic components constituting an electronic circuit on a surface opposite to one on which the air physical quantity sensing element is provided. The housing structural component is formed with a communication hole which allows the inside and the outside of the main air flow passage to communicate with each other. The electronic circuit board is mounted on the housing structural component such that the communication hole is separated into two and the surface on the side where the air physical quantity sensing element is provided faces the main air flow passage side.

### Effect of the Invention

According to the present invention, since a structure of physical quantity sensing device can efficiently absorb heat emitted from an internal combustion engine, it is possible to prevent dew condensation of a sensing element for detecting physical quantity of air.

### BRIEF DESCRIPTION OF THE DRAWINGS

FIG. 1 is a side cross-sectional view showing one embodiment of the present invention.

FIG. 2 is a side cross-sectional view showing one embodiment of the present invention.

FIG. 3 is a top view showing one embodiment of the present invention and a sectional view taken along line A-A thereof.

FIG. 4 is a top view showing one embodiment of the present invention.

FIG. 5 is a top view showing one embodiment of the present invention.

FIG. 6 is a side cross-sectional view showing one embodiment of the present invention.

FIG. 7 is a side cross-sectional view showing one embodiment of the present invention.

### REFERENCE NUMERALS

1 main air flow passage
2 air flow passage component
3 mounting hole
4 gasket
5 physical quantity sensing device
6 connector
7 connector terminal
8 housing structural component
9 physical quantity sensing element
10 electronic circuit board
12 metal wire
13 communication hole
15 groove
16 seal material
17 microprocessor
18 electronic component
19 through-hole
30 circuit protection layer
31 glass epoxy substrate
32 humidity sensing element
33 humidity sensor
34 gel
35 cover

### MODES FOR CARRYING OUT THE INVENTION

Specific configuration examples of the present invention will hereinafter be described.

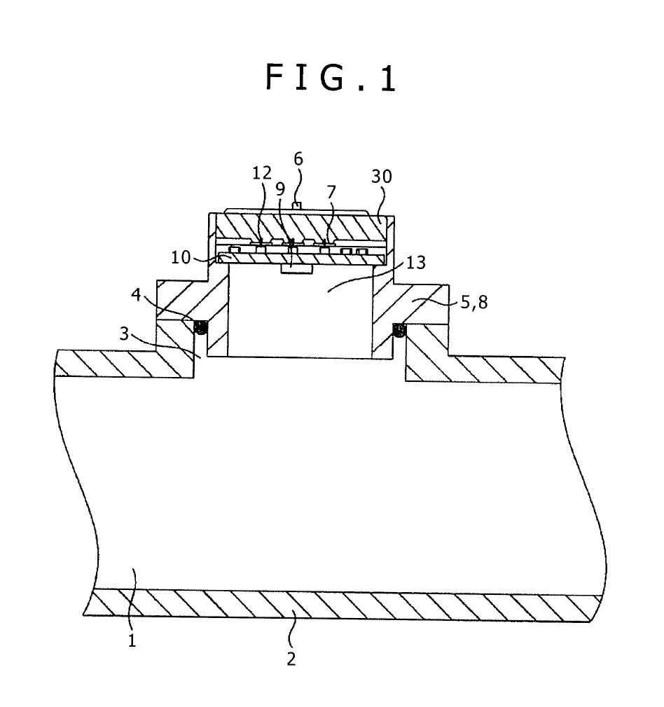

In FIG. 1, a part of an air flow passage component 2 that constitutes a main air flow passage 1 is provided with a mounting hole 3 of a sensor. A physical quantity sensing device 5 is mounted and fixed to the air flow passage component 2 via a gasket 4. The physical quantity sensor device 5 is substantially constituted by internally providing an electronic circuit board 10 mounted with a physical quantity sensing element 9 with a housing structural component 8 in which a connector 6 and a connector terminal 7 are integrally molded. The physical quantity sensor device 5 further forms a circuit protection layer 30 by, for example, direct casting of a resin, and thereby protects and stabilizes the electronic circuit board 10. The electronic circuit board 10 allows other circuits to be installed on a surface opposite to one on which the physical quantity sensing element 9 is mounted.

The connector terminal 7 and the electronic circuit board 10 are electrically connected using a metal wire 12, which enables external input and output through the connector 6. A communication hole 13 is formed in the housing structural component 8 so as to let the inside and outside of the main air flow passage communicate with each other. The electronic circuit board 10 is mounted at such a position as to separate the communication hole 13 into two and in such a manner that the physical quantity sensing element 9 faces the main air flow passage 1 side.

According to the present configuration, the physical quantity sensing element 9 used by being directly subjected to intake air, and other circuit parts by being completely hermetically protected are each mounted to opposing surfaces. It is therefore possible to realize in a simple structure two types of configuration: the first configuration that the physical quantity sensing element 9 is directly subjected to the intake air, and the other one that circuit parts which need mechanical protection are separated from contamination and corrosion so as to hermetically protect the circuit parts. As mentioned above, the present configuration is realized by simply providing the circuit protection layer 30 here.

Since the physical quantity sensing element 9 and other circuits are each mounted on the opposing surfaces of the electronic circuit board 10, the size of the overall electronic circuit board 10 can be reduced. The reduced size significantly contributes to downsizing of the physical quantity sensing device 5 itself.

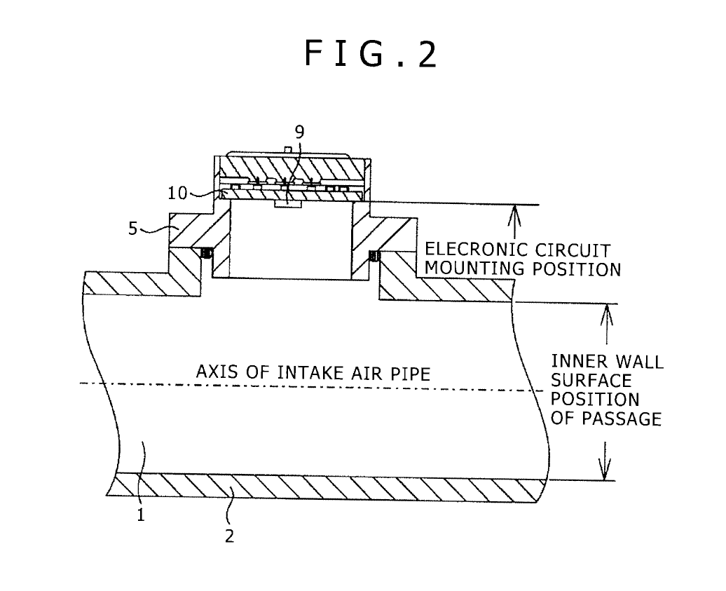

As shown in FIG. 2, the mounting position of the electronic circuit board 10 mounted with the physical quantity sensing element 9 is disposed in such a manner as to be in a position outer of an inner wall surface of the main air flow passage 1. The electronic circuit board 10 is further placed so as to be approximately parallel to the axial direction of an intake air pipe passage formed by the air flow passage component 2.

The present configuration allows heat emitted from an engine to be efficiently absorbed in the mounting position of the electronic circuit board 10. It also can create a relation of “the temperature of intake air is less than the temperature of each of the structure of the present device and the physical quantity sensing element 9” during most of the operating time of the physical quantity sensing device 5. An example is it will be possible to prevent dew condensation on the physical quantity sensing element 9 unit even in the eventuality of sudden change in the temperature and humidity of the intake air.

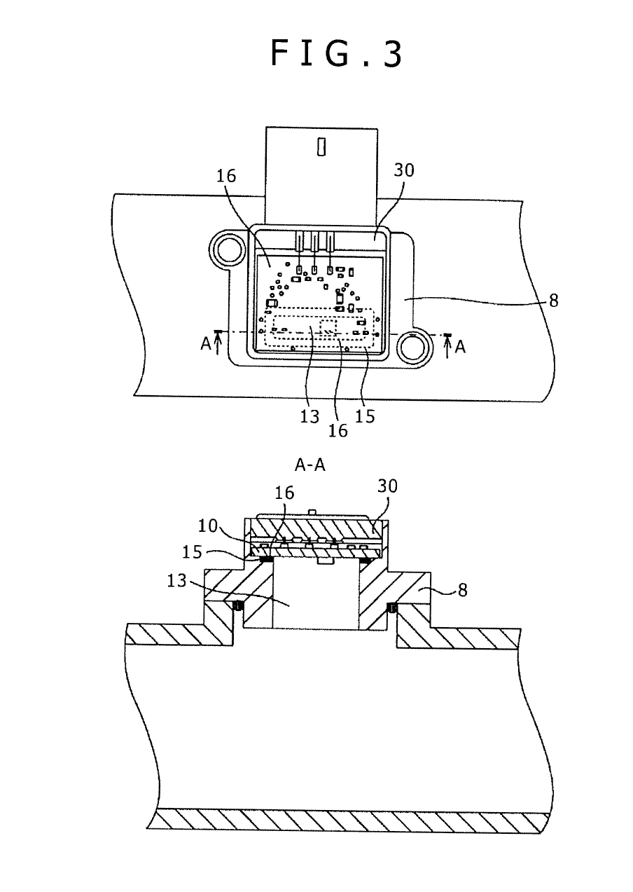

An enclosure structure of one embodiment of the present invention will now be explained using FIG. 3.

A groove 15 is formed in a part of the mounting surface of the electronic circuit board 10 on the housing structural component 8 in such a manner as to cover the overall communication hole 13. The electronic circuit board 10 is installed by applying a seal material 16 to the groove 15. There is thus provided a structure in which the communication hole 13 is perfectly hermetically separated with respect to the inside and outside of the intake air pipe.

The present configuration makes it possible to realize that a material being liquid in an uncured state can be used by being poured in the material that forms the circuit protection layer 30. It also can implement in a simple manufacturing method and structure the configuration where the physical quantity sensing element 9 is directly subjected to intake air, and other circuit parts are hermetically protected.

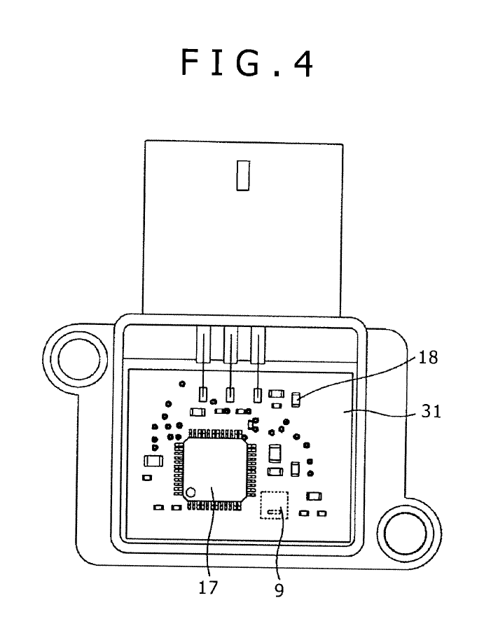

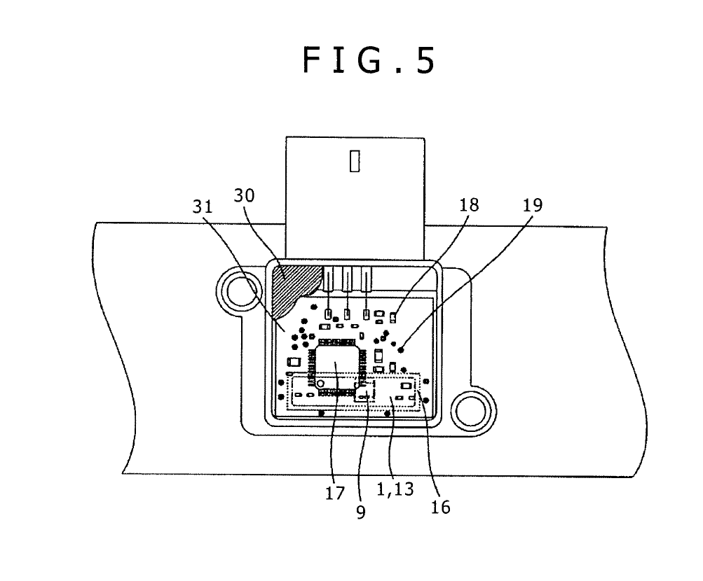

The electronic circuit board 10 will now be explained using FIGS. 4 and 5.

The physical quantity sensing element 9, located on the electronic circuit board 10 for which a glass epoxy substrate 31 is used, is mounted at the main air flow passage 1 side. A microprocessor 17 and electronic components 18 such as capacitors and resistors for processing and converting each signal of the physical quantity sensing element 9 are mounted on the surface opposite to the main air flow passage 1 side.

The microprocessor 17, a component packaged with a resin, makes linear expansion coefficients between resin material and a substrate material both included in the microprocessor 17 to correspond more easily when the microprocessor 17 is combined with the glass epoxy substrate 31. The combination further improves durability against cooling-heating shock cycles, for example, and supplies, over a long period of time, sensor signals high in reliability.

As shown in FIG. 5, with the aim of downsizing the electronic circuit board 10 and manufacturing it at low cost, the electronic circuit board 10 is provided with through-holes 19 to form a through multilayer board structure in which interlayer circuits are connected by the through-holes 19 arranged outside the applied region of the seal material 16.

The present configuration can prevent the material from flowing out to the communication hole 13 lying on the opposite side of the substrate via the through-holes 19 and prevent corrosive gas from entering from the main air flow passage 1 side to the electronic circuit side mounted with the microprocessor 17 and the electronic components 18 in reverse even if the material being liquid in an uncured state flows in the material for forming the circuit protection layer 30. It is therefore possible to adopt an inexpensive substrate having through-holes 19 and reduce the cost of the overall device.

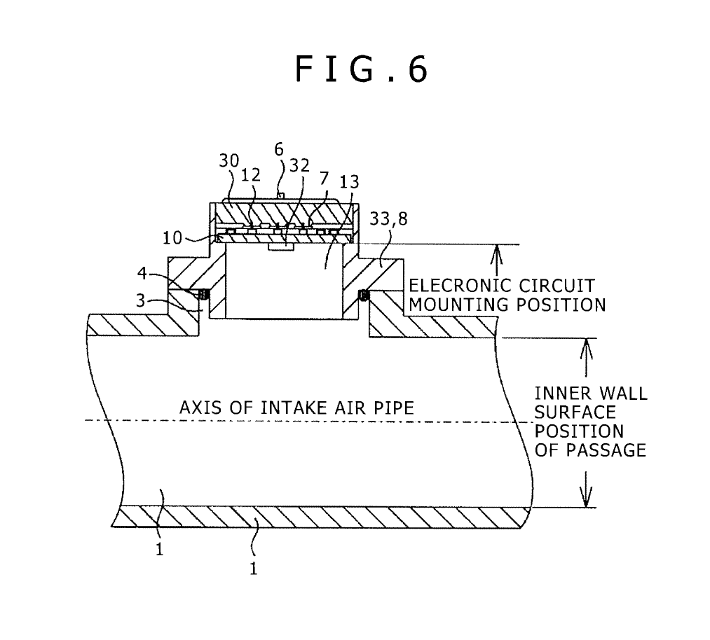

Another embodiment of the present invention will be described using FIG. 6. In the present embodiment, a description will be made of an example in which the previous embodiment is applied to a humidity sensor 33.

A part of an air flow passage component 2 that constitutes a main air flow passage 1 is provided with a mounting hole 3 of a sensor. A humidity sensor 33 is attached and fixed to the air flow passage component 2 with a gasket 4 in-between. The humidity sensor 33 is substantially configured by internally providing an electronic circuit board 10 mounted with a humidity sensing element 32 with a housing structural component 8 in which a connector 6 and a connector terminal 7 are integrally molded. The configuration of the humidity sensor 33 further includes a circuit protection layer 30 formed by, for example, direct casting of a resin, and the electronic circuit board 10 thereby protected and stabilized. The electronic circuit board 10 allows other circuits to be mounted on a surface opposite to one on which the humidity sensing element 32 is installed.

The connector terminal 7 and the electronic circuit board 10 are electrically connected using a metal wire 12, which enables external input and output through the connector 6. A communication hole 13 is formed in the housing structural component 8 so as to let the inside and outside of the main air flow passage communicate with each other. The electronic circuit board 10 is mounted at such a position as to separate the communication hole 13 into two and in such a manner that the humidity sensing element 32 faces the main air flow passage 1 side.

The mounting position of the electronic circuit board 10 mounted with the humidity sensing element 32 is disposed in such a manner as to be in a position outer of an inner wall surface of the main air flow passage 1. Further, the electronic circuit board 10 is placed so as to be approximately parallel to the axial direction of an intake air pipe passage formed by the intake air pipe passage constituent member 2.

The present configuration allows the humidity sensor 33 to efficiently absorb heat generated from an engine and create a relation of “the temperature of intake air<the temperature of each of the structure of the present device and the humidity sensing element 32” during most of the operating time of the humidity sensor 33. It is thus possible to prevent dew condensation on the humidity sensing element 32 even in the eventuality of sudden change in the temperature and humidity of the intake air.

As described above, the present invention is highly advantageous when applied to the humidity sensor 33 as well.

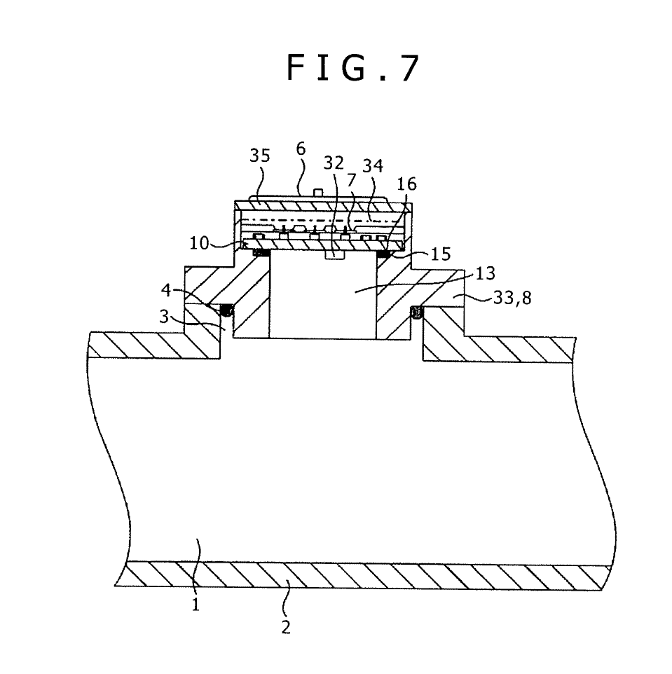

An enclosure structure of the humidity sensor 33 will be explained using FIG. 7.

A part of an air flow passage component 2 that constitutes a main air flow passage 1 is provided with a mounting hole 3 of a sensor. A humidity sensor 33 is attached to the air flow passage component 2 with a gasket 4 in-between. The humidity sensor 33 includes an electronic circuit board 10 mounted with a humidity sensing element 32, which is internally mounted in a housing structural component 8 where a connector 6 and a connector terminal 7 are integrally molded.

A communication hole 13 is provided beforehand in the housing structural component 8 so as to allow the inside and outside of the main air flow passage to communicate with each other. Further, a groove 15 is formed on the housing structural component 8 so as to surround the entire communication hole 13. The electronic circuit board 10 is mounted by applying a seal material 16 to the groove 15. There is thus provided a structure in which the communication hole 13 is perfectly hermetically separated with respect to the inside and outside of an intake air pipe.

The present device, used in an automobile internal combustion engine, needs to have a structure capable of withstanding the sudden positive pressure in the main air flow passage 1 generated by, for example, a backfire. A cover 35, therefore, may be adhered and fixed to the housing structural component 8 after, for example, the electronic circuit board 10 has been protected and stabilized by direct casting of a resin, or after the electronic circuit board 10 has been protected by gel 34 as shown in FIG. 7, without fixing the electronic circuit board 10 to the housing structural component 8 only by seal material 16.

The present configuration therefore makes it possible to realize in a simple structure two types of configuration: the first configuration that a material being liquid in an uncured state can be poured and used, and the humidity sensing element 32 is directly subjected to the intake air, and the other one that circuit parts which need mechanical protection are separated from contamination and corrosion so as to hermetically protect the circuit parts.

Since the humidity sensing element 32 and other circuits are each mounted on the opposing surfaces of the electronic circuit board 10, the size of the overall electronic circuit board 10 can be reduced, which significantly contributes to downsizing of the humidity sensor 33 itself.

1. An air physical quantity sensing device comprising:
a housing structural component integrally having a connector and a connector terminal member for performing input and output with the outside;
an electronic circuit board mounted on the housing structural component; and
an air physical quantity sensing element mounted on the electronic circuit board and capable of detecting physical quantity of air, the air physical quantity sensing device being attached and fixed using a part of the housing structural component to a mounting hole provided in advance at a part of a main air flow passage through which air flows, wherein:
the electronic circuit board is mounted with an electronic component included in an electronic circuit on a surface opposite to one on which the air physical quantity sensing element is provided;
the housing structural component is formed with a communication hole which allows the inside and outside of the main air flow passage to communicate with each other; and
the electronic circuit board is mounted on the housing structural component in such a manner that the communication hole is separated into two and the surface on the side where the air physical quantity sensing element is provided faces the main air flow passage side.

2. The air physical quantity sensing device according to claim 1, wherein the electronic circuit board is mounted on the housing structural component in a position outer of an inner wall surface of the main air flow passage.

3. The air physical quantity sensing device according to claim 2, wherein
a surface of the electronic circuit board where the air physical quantity sensing element is provided has a groove so as to surround the air physical quantity sensing element, and
the electronic circuit board is attached to the housing structural component by application of a seal material to the groove.

4. The air physical quantity sensing device according to claim 3, wherein the electronic circuit board is a glass epoxy substrate.

5. The air physical quantity sensing device according to claim 4, wherein
the electronic circuit board is provided with through-holes, and
each of the through-holes is provided outside the groove.

6. The air physical quantity sensing device according to claim 1, wherein the air physical quantity sensing element is a humidity sensing element.

7. The air physical quantity sensing device according to claim 1, wherein of the communication holes separated by the electronic circuit board, the communication hole on the other side that does not face the main air flow passage has an enclosure structure.
